(19) United States
(12) Patent Application Publication
(10) Pub. No.: US 2016/0166991 A1
(43) Pub. Date: Jun. 16, 2016

(54) Membrane Selective for Alcohols

(71) Applicant: VECTOR SEPARATIONS, LLC, St. Louis Park, MN (US)

(72) Inventor: Hiroshi Nomura, Shorewood, MN (US)

(21) Appl. No.: 14/566,349

(22) Filed: Dec. 10, 2014

(51) Int. Cl. B01D 61/36; B01D 71/26; B01D 67/00; B01D 69/08

(52) U.S. Cl. CPC B01D 61/366; B01D 69/08; B01D 71/26; B01D 67/009; B01D 2325/20; B01D 2323/34

(57) ABSTRACT

Polymeric membranes with greatly enhanced selectivities, permeation rates, and separation factors were formed by exposure of glassy polymers having high fractional free volume to an oxidizing gas plasma. Thusly treated membranes showed selectivities for low molecular weight alcohols (methanol, ethanol) versus water that were greater than 1.0, being as high as 10 to 15 during pervaporation. Mass transport rates for methanol reached the range of 500 to 1000 moles/m²-hr or higher in some instances which is more characteristic of vacuum membrane distillation than pervaporation. Devices made from plasma-treated polymethylpentene membranes were particularly effective concentrating alcohols selectively by evaporative methods, i.e. pervaporation/vacuum membrane distillation.

### FIELD OF THE INVENTION

This invention relates to the field of membranes useful in pervaporation and more specifically to membranes for alcohol separation from aqueous and nonaqueous media by evaporative methods.

### BACKGROUND OF THE INVENTION

Emphasis on use of renewable sources for energy production has highlighted the need for improved methods of separating and concentrating low molecular weight alcohols, especially methanol and ethanol but extending even to isomeric butanols. One area of emphasis is the production of biodiesel from natural fats and oils via transesterification. Alcohols such as methanol or ethanol are commonly used in transesterification processes to convert fatty triglycerides to monoesters. The monoesters are then incorporated into diesel fuels. Another area of emphasis is the development of biofuels via fermentation processes, wherein carbohydrate substrates are converted to low molecular weight alcohols such as principally ethanol or butanol. In biodiesel generation, triglycerides are converted into monoesters by replacing the glycerin with an alcohol. Commercially, this is accomplished by the Lurgi process, wherein anhydrous vegetable oils are exposed to an alcohol in presence of an alkali catalyst. There are many sources of waste fats and oils where the Lurgi process is not suitable because of contaminants and variability in quantity and quality of the source material. In processing of waste fats and oils, water is often a contaminant. Transesterification in the presence of water usually involves employing an excess of an alcohol (typically methanol), and recovery and recycle of excess unreacted alcohol is required as part of the biodiesel generation process. Pervaporation membranes are an attractive route to capture and recycle of the alcohol. In the case of alcohol production by fermentation, separation of alcohols from a fermentation broth or from filtrates or condensates derived from a fermentation broth represents an opportunity for pervaporation as a process step. Dehydration of alcohol-water azeotropes is one such application of pervaporation. Isolation of essentially anhydrous alcohols directly from fermentation broth via pervaporation represents another opportunity.

In pervaporation, a liquid feed is brought into contact with one surface of a membrane and a vacuum is applied to an opposite surface of the same membrane. A sought-after constituent in the liquid feed such as methanol or ethanol is absorbed from the liquid feed through the surface into the wall matrix of the membrane, permeates through the membrane wall, then exits from an opposite surface of the matrix wall, i.e. from the surface in contact with the vacuum, exiting as a vapor. The vacuum supplies the driving force for separation and transport of the sought-after constituent. A sweep gas at low partial pressure is often employed for sweeping the vapors away from the membrane and to a condenser. Three primary types of pervaporation membranes have been developed to date. Hydrophilic membranes based generally on crosslinked polyvinyl alcohol compositions have been developed for use with polar or hydrophilic constituents. These membranes are highly selective toward water and are capable of breaking and dehydrating azeotropes containing water as the minor ingredient. An example would be the selective removal of water from the 95/5 percent azeotrope of ethanol/water.

Hydrophobic membranes based on crosslinked silicone rubber compositions have been developed and find use for separating organic compounds out of their mixtures or blends with water or other aqueous media. Silicone rubber compositions are particularly attractive from the standpoint that diffusion rates of solutes through silicone rubber are faster than through most other polymeric compositions, including crosslinked polyvinyl alcohol compositions. However, silicone-based membranes are not noted to exhibit high selectivities. This illustrates a general rule in polymeric membranes: compositions with high transport rates exhibit low selectivities while compositions with high selectivities exhibit low transport rates. Furthermore, in regard to mass transport of water or alcohols, both these types of membranes are of limited commercial value because their overall transport rates are low in respect to process economics and demands made on them. Fluxes of water or alcohols through these polymeric membranes have generally been less than 2 moles/m²-hr. A notable review article on these polymeric pervaporation membranes is by Leland M. Vane, A Review of Pervaporation for Product Recovery from Biomass Fermentation Processes, (J. Chem. Technology and Biotechnology, Vol. 80, pp. 603-629, 2005).

Zeolite membranes represent a third type of membrane class useful in pervaporation. These membranes have been formed from a variety of zeolitic compositions and have been evaluated in a variety of pervaporative applications. An extensive review article by T. C. Bowen, R. D. Noble and J. L Falconer titled Fundamentals and Applications of Pervaporation through Zeolite Membranes (J. Membrane Science, Vol. 245, pp. 1-33, 2004) documented the progress of zeolite pervaporation membranes. Fluxes of zeolite membranes varied from less than 3 to as high as 19 moles/m²-hr at an operating temperature of 303° Kelvin (30° Celsius), with higher rates than these at elevated operating temperatures. Zeolite membranes are capable of fluxes five to ten times greater than those of the aforementioned polymeric membranes. Even so, only one large scale application of zeolite pervaporation membranes was identified and noted in the study by Bowen et al.

One approach commonly employed to increase transport rates is to generate porosity within the matrix wall of a membrane. Membranes with microporous walls are well known in the membrane art. Selectivity is maintained by reason of a dense surface skin covering the microporous wall. The surface skin can be of the same composition as the wall matrix. Alternatively, the skin may consist of a totally different polymer composition subsequently deposited onto a surface of a microporous membrane. Membranes of the latter type are sometimes referred to as thin film composite membranes, where the phrase “thin film” relates to the surface coating. The thin film or skin is commonly in the range of 0.1 to 2 microns thick. Polyvinyl alcohol separating layers deposited and crosslinked on microporous polysulfone base layers represents one type of thin film composite membrane having ostensibly good separation factors in azeotrope dehydrations. Many commercially available membranes both in and outside the particular field of pervaporation membranes make use of microporous walls and thin dense surface skins.

Despite enormous interest and efforts in the field of pervaporation over the years, wide scale adoption of pervaporation on an industrial scale has not occurred, as compared for example to microfiltration or reverse osmosis membrane processes. The mass transport rates of pervaporation membranes are low and lead to unattractive process economics. Vacuum membrane distillation has been evaluated as another approach to separations. Vacuum membrane distillation typically achieves fluxes that are several orders of magnitude higher than possible in pervaporation. Selectivity in the case of vacuum membrane distillation is determined primarily by vapor-liquid equilibrium conditions at a membrane-liquid interface. The relative solubilities and diffusivities of constituents, which are involved in pervaporation membranes and assist in selectivity, are not present in membrane distillation applications. A review article by Kevin W. Lawson and Douglas R. Lloyd titled Membrane Distillation (J. Membrane Science, Vol. 124, pp. 1-25, 1997) has documented progress on the various types of membrane distillation including vacuum membrane distillation, noting however that membrane distillation has been overshadowed by reverse osmosis in its most potentially lucrative application. The need for better membranes with mass transport capabilities on the scale of membrane distillation but with the selectivity achievable with pervaporation remains a challenge in the field of membrane separations.

### SUMMARY OF THE INVENTION

It is an object of the present invention to provide membranes having greatly improved mass transport rates toward low molecular weight alcohols while maintaining selectivity.

It is another object of the present invention to provide improved membranes for extracting low molecular weight alcohols selectively from blends of liquids encompassing both aqueous media and nonaqueous media when operated in a pervaporation mode.

It is a further object of the present invention to provide improved membranes capable of separating a low molecular alcohol such as methanol from its mixture with glycerine and water in the transesterification of waste fats and oils for production of biodiesel.

It is yet another object of the present invention to provide improved membranes that can selectively separate low molecular weight alcohols from fermentation broths directly or from filtrates, condensates or extracts of fermentation broths.

It is a further object of the present invention to provide a means for recovering an alcohol or alcohols from aqueous streams at mass transport rates characteristic of membrane distillation at selectivities characteristic of pervaporation.

It has now been discovered that certain polymeric membranes with greatly enhanced selectivities, permeation rates, and separation factors can now be formed by a relatively simple treatment process. Glassy polymers with high free volume, alternatively characterized as having high fractional free volume, may, in the form of skinned microporous membranes, be altered dramatically by exposure to an oxidizing gas plasma. The resulting thus-modified membranes show enhanced permeation rates and separation rates for low molecular alcohols versus water. These membranes are characterized by having selectivity for low molecular weight alcohols (methanol, ethanol) versus water that is greater than 1.0, being as high as 10 to 15. Simultaneously, these membranes are further characterized as having mass transport rates for low molecular weight alcohols that are greater than for essentially all prior polymeric pervaporation membranes and even for zeolite membranes. Mass transport rates for methanol can, in certain embodiments of the invention, reach the range of 500 to 1000 moles/m²-hr or higher. These high mass transport rates are believed to involve characteristics of membrane distillation membranes, meaning that the membranes of this invention combine both pervaporation and membrane distillation mechanisms in achieving the observed methanol transport rates. Ethanol mass transport rates are greatly improved as well, and can reach 170 moles/m²-hr or higher for comparable membranes under comparable conditions. They are made using polymers noted for having high free volume and preferably having as well a glass transition temperature of at least 25° C., which distinguishes them from rubbery compositions. Also, their ability to operate with performance levels not previously seen with pervaporation membranes is achieved by surface nanopore stabilization by treatment with a low temperature oxidizing gas plasma, especially a gas plasma generated by radiofrequency discharge through a blend of methane and air or oxygen at very low partial pressures.

### FIGURES

FIG. 1 is a schematic diagram of a gas plasma treatment apparatus.

FIG. 2 is a schematic diagram illustrating an approach for mounting fibers to be treated with a gas plasma.

FIG. 3 is a schematic diagram of a method of measuring transport characteristics of a hollow fiber module.

FIG. 4 is a graph of nitrogen permeabilities for membranes treated with varying gas plasma blends.

FIG. 5 is a graph of coating thickness deposition and removal as a function of methane-air ratio in a gas plasma.

FIG. 6 is a graph of nitrogen permeabilities for a second set of membranes treated with varying gas plasma blends.

FIG. 7 is a graph of temperature compensated mass transport rates of methanol, ethanol and water through membranes treated with varying compositions of oxidizing gas plasmas.

### DESCRIPTION

Certain embodiments of the present invention will now be further described in more detail, in a manner that enables the claimed invention so that a person of ordinary skill in this art can make and use the present invention. These and other embodiments, features, and advantages of the present invention will become more apparent to those skilled in the art when taken with reference to the following detailed description of the invention in conjunction with the accompanying drawings.

Unless otherwise indicated, all numbers expressing reaction conditions, concentrations of components, permeation rates, separation factors, and so forth used in the specification and claims are to be understood as being modified in all instances by the term “about.” Accordingly, unless indicated to the contrary, the numerical parameters set forth in the following specification and attached claims are approximations that may vary depending at least upon the specific analytical technique. Any numerical value inherently contains certain errors necessarily resulting from the standard deviation found in its respective testing measurements.

As used in this specification and the appended claims, the singular forms “a,” “an,” and “the” include plural referents unless the context clearly indicates otherwise. Any reference to “comprising” includes, in the alternative, “consisting essentially of or “consisting of in certain embodiments. Unless defined otherwise, all technical and scientific terms used herein have the same meaning as is commonly understood by one of ordinary skill in the art to which this invention belongs. If a definition set forth in this section is contrary to or otherwise inconsistent with a definition set forth in patents, published patent applications, and other publications that are herein incorporated by reference, the definition set forth in this specification prevails over the definition that is incorporated herein by reference.

The membranes of the invention which are described herein exhibit a novel and unique combination of properties for pervaporation membranes that equal or exceed membrane separation properties formerly attainable only by zeolite membranes or by combinations of pervaporation with vacuum membrane distillation. These separation properties are achieved using membranes comprising high free volume polymers, fashioned into permselective asymmetric membranes, then treated with an oxidizing gas plasma. The term permselective as used in the description of the invention means generally that the membranes are selective towards certain chemical species, specifically toward permanent gases on the basis of solution-diffusion models when used in reference to untreated polymer skin layers, and specifically toward low molecular weight alcohols such as methanol, ethanol, isomeric propanols, and isomeric butanols versus water when used in reference to plasma treated polymer skin layers when resulting membranes are utilized in pervaporation and membrane distillation applications.

By high free volume is meant the unoccupied space between molecules in a polymer, and this space allows for sorption and movement of molecules such as gases and small organic compounds through the polymer matrix. Fractional free volume is defined according to the equation

$${F}_{v} = \frac{V - 1.3 {V}_{w}}{V}$$

where V is the specific volume (reciprocal of density) and V_{w} is the specific van der Waals volume. A method of measuring fractional free volume in polymers is given in U.S. Published Pat. Appl. 2012/0042777 A1, which is hereby incorporated in its entirety by reference thereto. In terms of fractional free volume, most glassy polymers have fractional free volumes in the range of 0.10 to 0.22, whereas the polymers useable in this invention preferably have fractional free volumes in the range of 0.25 to 0.40, fractional free volume being by definition a dimensionless term. Fractional free volume for a specific sample of a high free volume polymer may vary depending upon thermal history of the sample, including such things as processing temperature and any annealing post-treatments. In the context of the invention, it is advantageous to adopt polymers and processing methods that foster the highest fractional free volume characteristics in the preparation of membrane substrates and their subsequent treatment by oxidizing gas plasmas to generate the membranes of the invention.

In the context of this invention, high free volume polymers are generally linear glassy polymers having bulky side groups that inhibit close packing of the polymer chains. By glassy polymer is meant a polymer having a glass transition temperature of at least 25 degrees Celsius. A well known example of a polymer which is herein found to be a suitable high free volume glassy polymer in the context of the invention is poly(4-methyl-1-pentene), commonly referred to as polymethylpentene and sometimes simply as PMP. Other known examples are copolymers of tetrafluoroethylene having bulky side groups such as perfluoro-2,2-dimethyl-1,3-dioxole or perfluoroalkoxy groups distributed along their backbone. The former is referred to by the tradename Teflon AF₅® and the latter is in commercial use and is referred to under the tradename Teflon-PFA® by DuPont. Another example is a polymer of trimethylsilyl propyne, which has trimethylsilyl groups distributed along its backbone and which polymer is said to have the highest fractional free volume of any known polymer as of this time, being 0.35 or higher depending upon thermal history. Membranes formed from PMP are commercially available under the trade name OxyPlus® from Membrana GmbH. Polymethylpentene itself is available in resin form under the tradename TPX® from Mitsui Chemicals America, Inc. Numerous reports on the synthesis and properties of poly(trimethylsilyl pentyne) have been published in technical literature to date. Its synthesis and use in forming gas separation membranes has been disclosed in U.S. Pat. No. 4,859,215, which is hereby incorporated in its entirety by reference thereto.

In one embodiment of this invention, an asymmetric membrane is formed from a high free volume polymer or otherwise obtained, this membrane having a dense surface skin showing gas selectivity toward permanent gases such as nitrogen, oxygen and carbon dioxide, the skin being integrally bonded to a microporous under layer of the same composition. This membrane is used as a membrane substrate for making a membrane of the present invention by exposing this membrane substrate to an oxidizing gas plasma, wherein the gas plasma contains preferably oxygen as a gaseous component, wherein the skin layer is modified by the oxidizing gas plasma. In another embodiment of the present invention, a thin film composite membrane is formed wherein a thin surface skin of the high fractional free volume polymer is deposited as a coating on a microporous support. Such supports include microporous polymers such as polysulfone, polyphenyleneoxide, polycarbonate, or polybenzimidazole, for example. Or the microporous support may be of inorganic nature, such as zeolite or ceramic materials or a finely porous carbon. The surface skin is preferably 0.1 to 10 microns thick, more preferably 0.2 to 5 microns thick, most preferably 0.5 to 2 microns thick. Gas plasma treatments typically penetrate up to about one micron depth in polymer skins, and it would appear that a skin thickness of about one micron of the high free volume polymer best matches the nature of the treatment process.

In another embodiment of the invention, a plurality of membranes formed and treated in the above-mentioned manner are arranged in a device suitable for operation in a pervaporation or membrane distillation mode. Such a device may consist of flat sheet membranes wound into spiral elements or sealed into plate and frame geometries. Alternatively, such a device may consist of tubular or hollow fiber membranes suitably potted or sealed into tube-and-shell geometries. In regard to the present invention, hollow fiber devices are particularly preferred.

Regarding the makeup of the oxidizing gas plasma, oxygen may be the sole gaseous component in the gas stream in which a plasma glow discharge is initiated. It is convenient, however, to use air as a source of oxygen, with the presence of nitrogen from air being not ostensibly detrimental to final membrane properties. Other gases or vapors may be included in the gas stream admitted to the glow discharge zone. Argon and methane are examples of such gases that may be advantageously blended in with the oxygen source. It is generally preferable, however, not to blend in readily polymerizable monomers to any significant concentration level as gas plasma ingredients because of the likelihood of deposits being formed on the surface skin. Examples of some readily polymerizable monomers include unsaturated species such as benzene, styrene, ethylene, acrylic acid, vinyl acetate, and methyl acrylate, and various disiloxanes and disilanes. Deposition of plasma polymers onto the surface of the treated membrane, while possible and perhaps non-detrimental in some instances, generally runs counter to the direction of the invention, which is to enhance the permeation rates of low molecular weight alcohols through the treated layer of the membrane. Deposition of an additional membrane layer, i.e. a plasma polymerizate, would almost always slow down permeation rates of the desired permeating species. Gases which are resistant to plasma polymerization may be blended in with air or oxygen, examples of such gases being argon, nitrogen and methane. Methane appears to be beneficial as a blend with air, such blends having been found to advantageously harden porous membranes by plasma annealing as disclosed in U.S. Pat. No. 6,203,850, which is hereby incorporated in its entirety by reference thereto. All gas plasmas tend to deposit at least some chemical moieties on any exposed surface in the plasma zone. However, depending on the plasma composition, the net effect may involve either a buildup of a deposit or actual stripping away of material from the exposed surface, i.e. the opposite of deposition. It is preferable that gaseous blends containing oxygen be of a nature that fosters anti-deposition. Deposition rate or the opposite thereof can be ascertained by means of a quartz crystal thickness monitor device. For instance, a quartz crystal resonator was used in work on the present invention to monitor deposition rates.

The membrane to be treated with an oxidizing gas plasma may be in the shape of a sheet, a continuous roll of film, a capillary fiber, or a tubular form larger than a capillary fiber. The membrane may be free standing or on a supporting structure such as a paper or webbing. Capillary fibers are in themselves normally self supporting. But a coating of the high free volume polymer on a microporous base of another polymer, even in hollow fiber form, is also acceptable. With regard to commercial applicability of the membranes of this invention, devices in the shape of spiral wound modules or in the shape of capillary bundles are economically attractive. Because pervaporation have heretofore tended to be characterized by inherently low mass transfer rates, and because capillary fibers pack more surface area into a membrane device, modules containing a plurality of capillary fiber membranes appropriately potted or otherwise mounted in place are generally preferred in the practice of pervaporation. In the case of this invention, building upon the knowledge base of hollow fibers and their handling is an advantage, even in view of the high transport rates that are now achievable.

A gas plasma is generated by glow discharge through a gas or blend of gases at low pressure. An essential component of an oxidizing gas plasma is oxygen. Oxygen may be admitted to the gas plasma as the pure gas or as a mixture with other gases, or otherwise generated in the plasma zone. Air, being a naturally occurring blend of nitrogen with oxygen, is a particularly advantageous source of oxygen, being the least expensive source of oxygen. Further, the diluent nature of the nitrogen in air allows for greater measure of control of the addition rate of oxygen to a plasma reactor, as compared to the addition of pure oxygen. The presence of nitrogen does not appear to significantly impede or enhance the effectiveness of oxygen in forming an oxidizing gas plasma.

As to the plasma treatment process, methods of inducing a glow discharge through a gaseous medium include use of microwave, audiofrequency and radiofrequency radiation. The pressure of the gas or gas blend in the oxidizing gas plasma treatment process may be varied within the range of 0.01 to 2 torr. A preferred range of operating pressure is 0.05 to 1 torr. Particularly preferred is an operating pressure of about 0.05 to 0.2 torr. The partial pressure of oxygen in a gaseous blend being admitted to the zone of glow discharge is preferably in the range of 0.01 to 1.5 torr, more preferably in the range of 0.01 to 0.5 torr. In the case of a blend of air and methane, the ratio of oxygen partial pressure to the partial pressure of the gaseous blend feed may be varied from 0.01 to 2.0, more preferably from 0.02 to 1.0. A torr is defined as exactly 1/760 of a standard atmosphere. Suitable upper and lower limits of the operable range of oxygen concentration will generally depend to some extent upon the shape and design of a plasma treatment apparatus, variations in the form and composition of incoming membranes to be treated, mechanism of generation of the glow discharge (whether by audiofrequency, radiofrequency, or microwave), substrate residence time in the plasma treatment zone, and power level or intensity of the glow discharge. In practice, suitable conditions of plasma treatment may be readily determinable by one of ordinary skill in the art in light of information disclosed in the present specification.

Radiofrequency (RF) methods are generally preferred for generating glow discharge gas plasmas. The glow discharge may be generated between a single capacitatively charged electrode and an adjacent ground electrode or by means of a pair of RF capacitatively coupled electrodes. The electrodes may mounted externally to the vacuum chamber or within a vacuum chamber itself, defining the glow discharge zone. Of the pair of electrodes, one is normally a ground electrode. External electrodes are typically mounted on RF-transparent members, such as quartz or high silica glass materials. Externally mounted electrodes are generally operated at higher discharge power than internally mounted electrodes, because of the intervening glass members, in order to activate and maintain a gas plasma state. Discharge power levels equal to, but not limited to, 25 to 200 watts are commonly used for this purpose, and are suitable for the practice of the invention. For internally mounted electrodes, applied power of 25 to 50 watts is applicable and sufficiently effective in most plasma treatment operations. A broad range of radiofrequencies may be employed to generate a gas plasma, but because of radio interference potential, an assigned frequency of 13.56 MHz is commonly used. The glow discharge may be continuous, or it may be intermittent during the oxidizing plasma treatment process. A continuous glow discharge process is generally preferred in the practice of this invention.

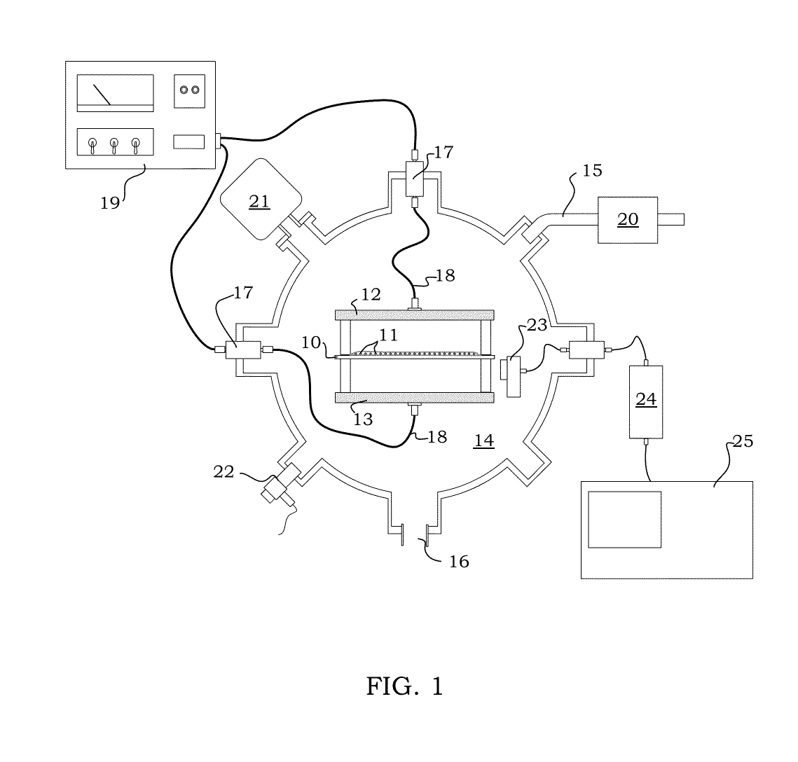

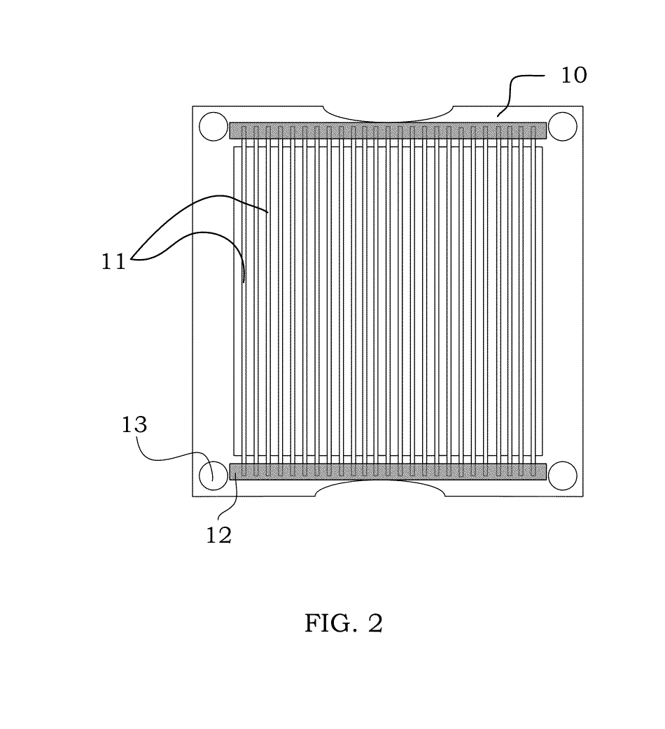

FIG. 1 discloses a design of an apparatus for batch treatment of membrane substrates by gas plasma treatment operations. This particular design is not to be taken as limiting in the practice of gas plasma treatments, but illustrates one method that may be employed to generate membrane embodiments of the present invention. In the schematic design shown in FIG. 1, a sample mounting frame 10 containing an array of moderate lengths of fibers 11 mounted thereon, preferably with individual fibers not in touching contact with one another, is placed in a zone between a radiofrequency emitting electrode 12 and a ground electrode 13 within a vacuum chamber 14. The chamber has a monomer inlet port 15 connected to it for introduction of a gas or gas blend, and an outlet port 16 connected to a vacuum source for maintaining a vacuum while also removing exhaust gases. The vacuum chamber also has electrical feedthrough ports 17 for introduction of electrical cables 18 in connection with a radiofrequency generator 19. A gas flow controller 20 is connected to the inlet port 15 to control the rate of vapor delivery to the vacuum chamber. The vacuum chamber 14 is further equipped with a pressure transducer 21 for measurement of the vacuum level in the chamber 14, and also with a pressure release valve 22. A thickness monitor sensor 23 is mounted adjacent to the glow discharge zone so as to be in contact with the glow discharge plasma. It is in turn connected electrically to a thickness monitor oscillator 24 and thereby to a thickness monitor console 25. In this apparatus for example, a suitable thickness monitor is a Leybold Inficon Thin Film Thickness and Rate Monitor. An access plate (not shown), optionally containing a view port, provides a means of access into the vacuum chamber. The electrodes are internally located in the vacuum chamber as shown in FIG. 1, but designs are feasible where the electrodes may be mounted externally to the vacuum chamber. FIG. 2 shows one means of mounting hollow fibers for plasma treatment in the above apparatus. A two-sided adhesive tape 12 is applied to opposite ends of a nonmetallic frame 10, and hollow fibers 11 are stretched across an open center of the frame, being held in place by the adhesive tape. Apertures 13 are located at corners of the frame 10 providing means for mounting the frame between electrodes in the gas plasma apparatus.

Other variations in the design and operation of a gas plasma apparatus may be utilized, as would be evident to one of skill in the art. In particular, a design is illustrated in U.S. Pat. No. 5,439,736, which is herein incorporated in its entirety by reference thereto, wherein a hollow fiber may be continuously passed through a glow discharge zone in a reaction tunnel, the fiber being rolled from an unwind spool to a rewind spool. Yet other apparatus designs and other means of bringing a membrane substrate into contact with a gas plasma may be employed wherein the substrate may be a flat sheet handled roll-to-roll, for example. In any of these designs, exposure of a porous substrate to a oxidizing gas plasma may also be employed for a time sufficient to modify the surface of the substrate to suitable effect. The exposure may be of a continuous nature or of an intermittent nature. The vacuum chamber may be formed of any material with sufficient strength to withstand the pressure difference between the chamber's interior and exterior, and with sufficient chemical and thermal resistance to withstand continuous exposure to a gas plasma contained therein. Presently, steel or stainless steel compositions are sufficient for wall members, and high silica glasses have been found to be satisfactory for view ports.

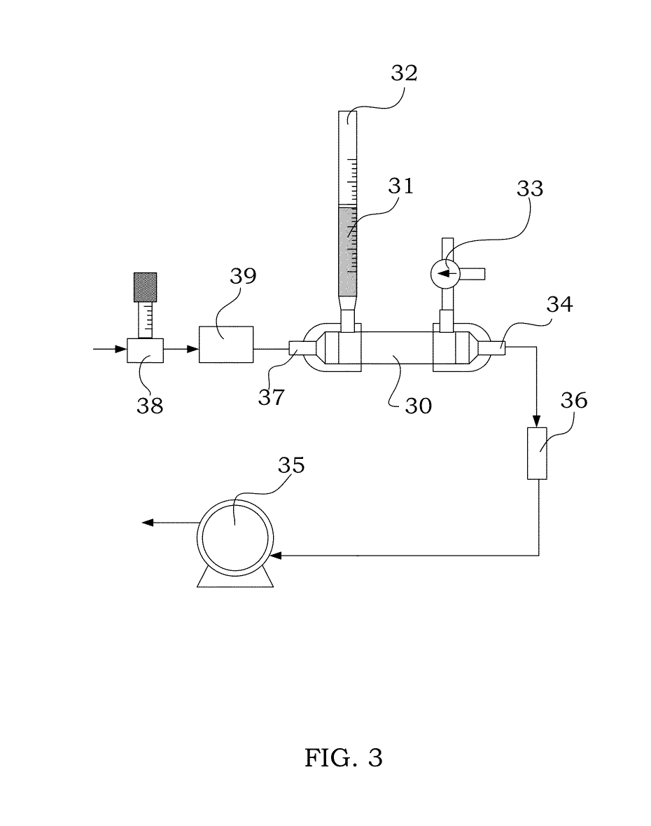

To determine selectivities and transport characteristics of membranes made in accordance with the present invention, where these membranes are in the form of hollow fibers, a test apparatus illustrated in FIG. 3 was used. Shown in FIG. 3 is a schematic drawing of an apparatus wherein membrane in the form of hollow fibers has been first assembled into a hollow fiber module 30. A liquid 31 such as water or an alcohol is placed in a graduated pipette 32, which is in connection with the shell side of a hollow fiber module 30. A valve 33 is also located on a shell-side port to allow for priming the shell side with the test liquid. By shell side is meant the volumetric space between the external surfaces of the individual fibers and the internal surface of the containment wall, i.e. shell, of the module. A vacuum is drawn on a lumen-side outlet 34 of the module by means of a vacuum pump 35 or other source. A pressure gauge 36 is located between the module outlet and the vacuum source. Optionally, an air sweep is introduced through an inlet port 37, and its flow rate is controlled by means of a needle valve 38 in conjunction with a flow meter 39. This apparatus is designed to measure permeation through an outside skin, i.e. separating layer, on a hollow fiber membrane. For a hollow fiber membrane having a separating layer on the lumen surface, the arrangement in FIG. 3 may be simply reversed so that the pipette is connected to a lumen-side port, the vacuum source is connected to a shell-side port, and valving and the optional air sweep are similarly relocated in an appropriate manner. The level of the liquid in the pipette 32 drops as a function of the rate of transport of the liquid through the membrane. In the case where the permeability of a gas is to be measured, the gas is supplied to the pipette inlet port under pressure, a flow meter is located at the outlet port 34, and the gas permeation flow rate is measured by means of the flow meter. Permeation rates for gases and liquids are conveniently measured in terms of P/l wherein P is the barrer permeability in cm³-cm/cm²-sec-cmHg and l is the thickness of the separating layer in centimeters (cm). Input pressure of the gas was in the range of 0.34 to 2.04 atm (5 to 30 psig) depending upon the specific gas, where fast permeating gases were introduced at the low end of the pressure range and slow permeating gases were introduced at the high end of the range. In the case of liquids, permeation rates were calculated for the liquids in condensed form, results being expressed in liters per square meter of membrane area per hour (1/m²/hr), which were restated (for purposes of comparison to reported literature values) to be in moles/m²-hr by a simple calculation employing the specific density of the constituent liquid and the molecular weight of the constituent. Permeation data were gathered at a vacuum draw of about 500 mm Hg (20 inches Hg or 0.67 atm). In all these examples, the permeant species was introduced to the treated skin and not to the underlying microporous matrix. This avoided any form of concentration polarization that would have been attendant to “backside” introduction of the permeating species.

Turning now to a discussion of experimental data, skinned hollow fiber membranes treated with oxidizing gas plasmas under various conditions were tested for pervaporation permeation characteristics by evaluation in the form of a small 0.5-inch diameter module. A bundle of 50 lengths of coated fiber was inserted into a polycarbonate tube and potted at each end with an epoxy potting resin. The ends of the potted bundle were shaved to open the lumens of the potted fibers. Effective membrane length of the bundle was 2.5 inch, and surface area of the membrane was 37.2 square centimeters. The resulting modules were tested for permeation rates to selected gases individually by feeding the pure gases to the shell side of the fibers at a pressure of 0.34 to 2.04 atm (5 to 30 psig) and measuring the flux of gas permeate from the lumen side. Pervaporation characteristics of the modules toward water and low molecular weight alcohols were tested by using the liquid form of the compound as a feed to the module as discussed above in conjunction with FIG. 3. A vacuum draw of about 500 mm Hg (corresponding to about 20 inches Hg) was used as a convenient standard operating condition for pervaporation.

### Comparative Example 1

Baseline permeability data were gathered on unmodified hollow fiber membranes made of the high free volume polymer polymethylpentene. These membranes were obtained from Membrana GmbH under the tradename OxyPlus® and consisted of hollow capillary fibers having a microporous wall and a thin dense surface skin on the outer periphery. Permeability data were obtained for four permanent gases—nitrogen, oxygen, carbon dioxide, and methane—and the averages of three determinations each are shown in Table 1, including both permeability and selectivity. Nitrogen was used as a standard gas for comparison of gas selectivities. The data in Table 1 are consistent with solubility and diffusion rates for these gases permeating through a dense, nonporous skin or layer of a polymer.

TABLE 1

| P/l | | | | | | | |
|---|---|---|---|---|---|---|---|
| (cm³/cm²-sec-cmHg) × | | | | | | | |
| 10⁴ | | | | Selectivity (X/N₂) | | | |
| N₂ | O₂ | CO₂ | CH₄ | N₂ | O₂ | CO₂ | CH₄ |
| 0.80 | 2.17 | 5.84 | 1.76 | 1.00 | 2.70 | 7.27 | 2.19 |

Permeabilities of water, methanol and ethanol were also determined and were as follows: water, 5.57 cm³/cm²-sec-cmHg×10³; methanol, 2.52 cm³/cm²-sec-cmHg×10³; ethanol, 1.10 cm³/cm²-sec-cmHg×10³. Selectivity of methanol versus water was 0.45; of ethanol versus water, 0.20. Particularly notable is the observation that water permeability through the membrane device is considerably higher than corresponding data for methanol and ethanol on a molecular basis. This is as one would anticipate based on molecular weight and kinetic size of the three liquids respective to one another.

### Example 1

Polymethylpentene hollow fibers of the same source and composition as in Comparative Example 1 were treated with an oxidizing gas plasma under a varied set of conditions wherein blends of air with methane were subjected to an radiofrequency generated glow discharge and the hollow fiber membrane substrates were treated with these gas plasmas. Gas plasma excitation was by radiofrequency signal excitation at a power level of 50 watts and exposure time was 5 minutes. The ratio of methane to air in plasma blends was varied from 100% methane to 100% air. Specific blends that were used included 100/0, 75/25, 50/50, 25/75, 12.5/87.5, and 0/100 molar % methane/air respectively. The treated hollow fibers of polymethylpentene were potted into small modules as was described above, then tested for gas, alcohol, and water permeabilities. Table 2 contains gas permeation characteristics of the resulting membranes toward nitrogen, oxygen, carbon dioxide and methane. Results showed that, at gas plasma treatments at methane/air blend

TABLE 2

| | | P/l | | | | | | | |
|---|---|---|---|---|---|---|---|---|---|
| | | (cm³/cm²-sec-cmHg) × | | | | | | | |
| | | 10⁴ | | | | Selectivity (x/N₂) | | | |
| | | N₂ | O₂ | CO₂ | CH₄ | N₂ | O₂ | CO₂ | CH₄ |
| Untreated Fiber | | 0.80 | 2.17 | 5.84 | 1.76 | 1.00 | 2.70 | 7.27 | 2.19 |
| % | | | | | | | | | |
| Air | % CH₄ | | | | | | | | |
| 0 | 100 | 0.12 | 0.12 | 0.15 | 0.27 | 1.00 | 1.07 | 1.33 | 2.32 |
| 25 | 75 | 0.30 | 0.26 | 0.27 | 0.48 | 1.00 | 0.88 | 0.91 | 1.59 |
| 50 | 50 | 0.61 | 0.57 | 0.49 | 0.83 | 1.00 | 0.93 | 0.79 | 1.35 |
| 75 | 25 | 1.10 | 0.98 | 0.84 | 1.68 | 1.00 | 0.89 | 0.76 | 1.53 |
| 87.5 | 12.5 | 29.90 | 28.20 | 26.30 | 39.10 | 1.00 | 0.94 | 0.88 | 1.31 |
| 100 | 0 | 39.59 | 41.53 | 37.30 | 48.64 | 1.00 | 1.05 | 0.94 | 1.23 |

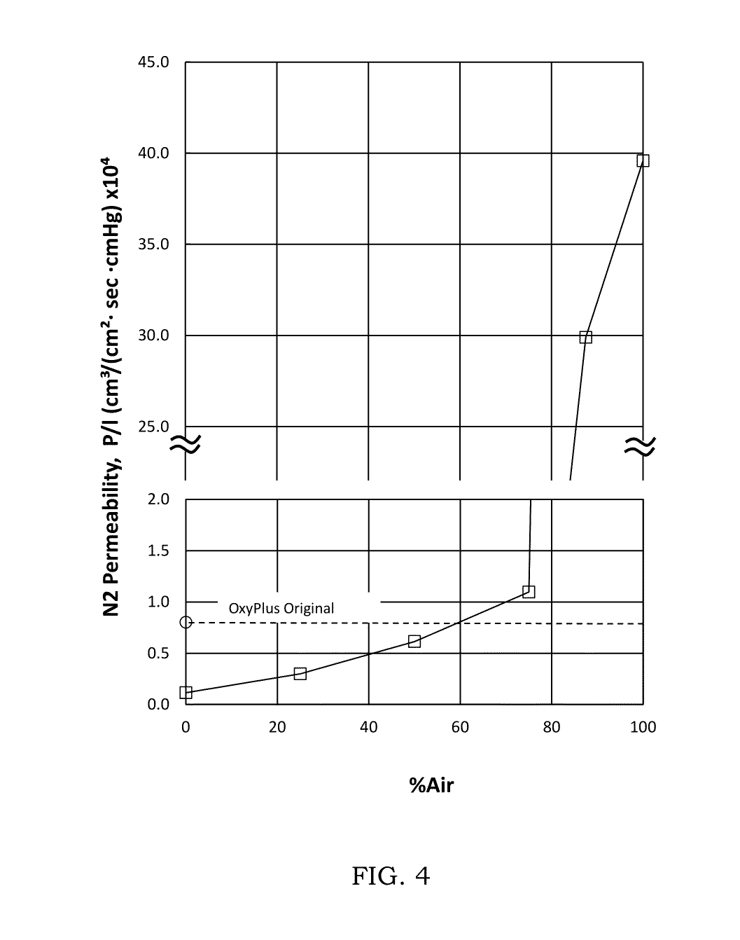

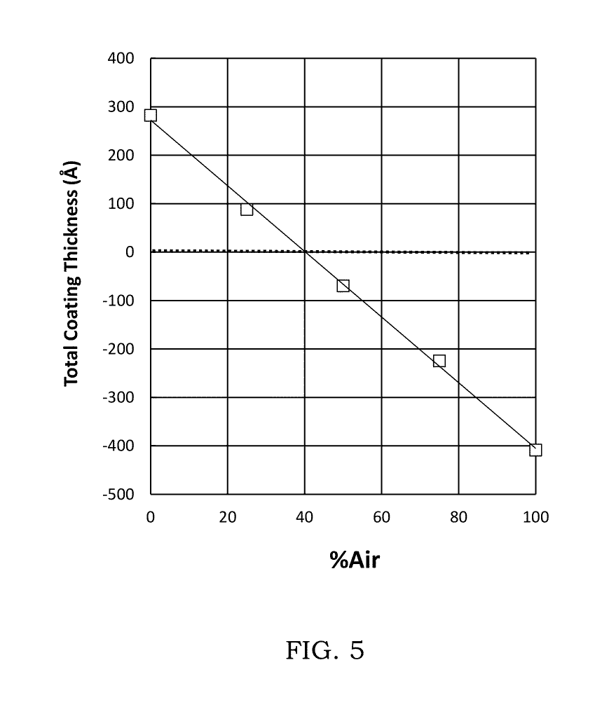

compositions above about 25% methane, permeation rates were reduced overall, presumably because of deposition of gas plasma constituents in the skin layer. However, at lower methane/higher air concentrations, permeability of the four permanent gases eventually switched over to essentially porous flow, with selectivity being generally governed by molecular size as opposed to solubility and affinity toward a wall matrix polymer. This is particularly evident at 87.5% air and higher. FIG. 4 shows nitrogen permeability data, wherein nitrogen permeation rate is plotted as a function of gas plasma air content. The curve appears to indicate that the plasma became an oxidizing gas plasma at a threshold of about 50% air/50% methane, becoming increasingly oxidizing in nature beyond that blend level. Use of a coating thickness monitor, whose positioning was shown in the FIG. 1 schematic, gave results shown in FIG. 5, wherein total coating thickness is plotted as a function of incoming gas blend. The resulting graph showed a changeover from deposition of a coating to ablation of a coating, the changeover occurring near the 50% methane/50% air blend. The two techniques are in rough agreement in implying onset of an oxidizing nature to the glow discharge at around 50% air content, becoming more pronounced at higher air concentrations in the blend. Effectiveness of the oxidizing gas plasma was particularly evident, however, a blend levels having greater than 75% air.

Table 3 contains permeation data on water, methanol, and ethanol through these plasma treated membranes as a function of incoming methane-air blends. The data in Table 3 show a dramatic rise in permeability, mass transport, and selectivity ratio for methanol and for ethanol relative to water at oxidizing gas plasma conditions above the 25/75 blend of methane/air, wherein the 25/75 blend corresponds to a gaseous volumetric ratio of approximately 25% methane, 16% oxygen and 59% nitrogen in the glow discharge gas plasma. The effect of the treatment with the oxidizing gas plasma is exceedingly beneficial at blend ratios greater than 75% air. Mass transport rates in moles/m²-hr reached levels as high as 170 to 908, which levels have not been previously reported even for zeolite membranes. These mass transport levels appear to indicate a hybridization of the treated membranes into a new type of membrane class combining pervaporation and membrane distillation together into a new mode of operation.

TABLE 3

| | CH₄/Air Blend | | | | | |
|---|---|---|---|---|---|---|
| | 100/0 | 75/25 | 50/50 | 25/75 | 12.5/87.5 | 0/100 |
| P/l | | | | | | |
| (cm³/cm²-sec-cmHg) × | | | | | | |
| 10³ | | | | | | |
| H₂O | 3.28 | 3.55 | 2.98 | 3.23 | 4.45 | 5.03 |
| Methanol | 0.87 | 1.00 | 2.09 | 2.93 | 32.70 | 61.84 |
| Ethanol | 0.31 | 0.40 | 5.69 | 2.26 | 17.68 | 38.50 |
| Selectivity Ratio | | | | | | |
| (vs. H₂O) | | | | | | |
| H₂O | 1.00 | 1.00 | 1.00 | 1.00 | 1.00 | 1.00 |
| Methanol | 0.27 | 0.28 | 0.70 | 0.91 | 7.35 | 12.28 |
| Ethanol | 0.09 | 0.11 | 1.91 | 0.70 | 3.97 | 7.65 |
| Mass Transport | | | | | | |
| (moles/m²-hr) | | | | | | |
| H₂O | 3.9 | 4.2 | 3.4 | 3.9 | 5.1 | 5.9 |
| Methanol | 20 | 15 | 31 | 43 | 480 | 908 |
| Ethanol | 2.9 | 3.9 | 55 | 22 | 170 | 370 |

### Example 2

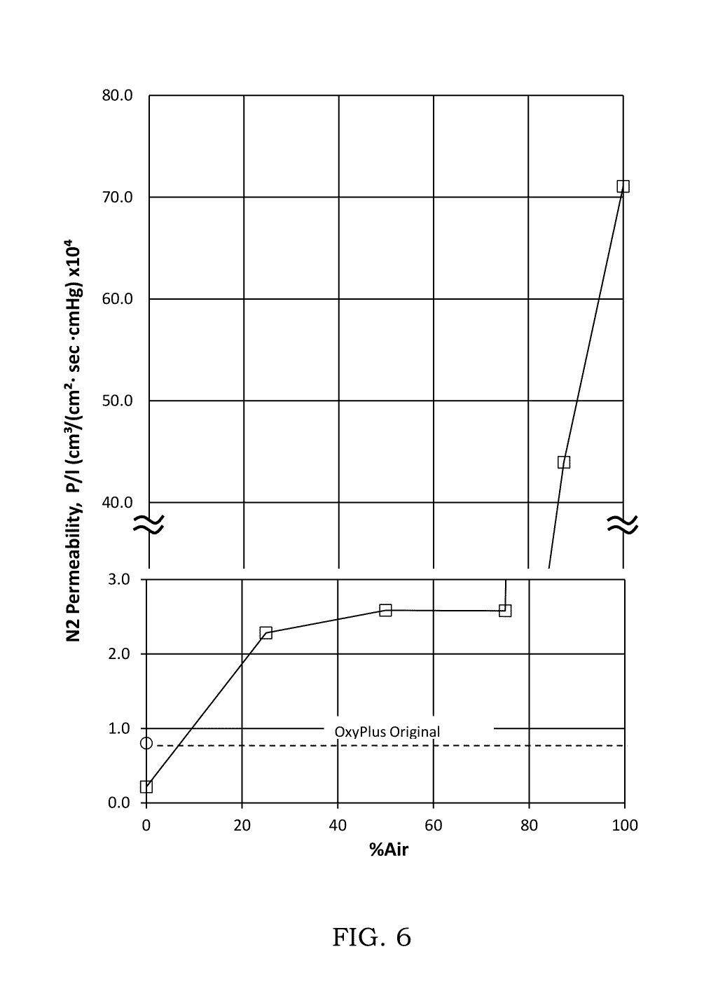

A second set of membrane substrates of the same type as in Example 1 were treated in the same manner using the same variation in methane-air blends for glow discharge plasma generation. Results are shown in Tables 4 and 5. Nitrogen gas permeabilities are shown in a graph in FIG. 6. These data points show enough variation from the membrane set of Example 1 to indicate the variability one might encounter in preparing multiple samples and running comparative permeation measurements on ostensibly duplicate samples. However, the effect of oxidizing gas plasma treatment at the high air-to-methane ratios is again highly evident, with the major change in permeabilities occurring above blend ratios greater than 75% air. As previously seen, the permeability of the four permanent gases eventually switched over to essentially porous flow, with selectivity being generally governed by molecular size as opposed to solubility and affinity toward a wall matrix polymer. This was again particularly evident at plasma gaseous blends containing 87.5% air and higher.

TABLE 4

| | | P/l | | | | | | | |
|---|---|---|---|---|---|---|---|---|---|
| | | (cm³/cm²-sec-cmHg) × | | | | | | | |
| % | % | 10⁴ | | | | Selectivity (x/N₂) | | | |
| Air | CH₄ | N₂ | O₂ | CO₂ | CH₄ | N₂ | O₂ | CO₂ | CH₄ |
| 0 | 100 | 0.22 | 0.25 | 0.45 | 0.32 | 1.00 | 1.18 | 2.09 | 1.47 |
| 25 | 75 | 2.28 | 2.06 | 1.88 | 3.69 | 1.00 | 0.90 | 0.82 | 1.62 |
| 50 | 50 | 2.59 | 2.34 | 2.17 | 4.07 | 1.00 | 0.98 | 0.84 | 1.58 |
| 75 | 25 | 2.58 | 2.52 | 2.93 | 4.12 | 1.00 | 0.98 | 1.14 | 1.60 |
| 87.5 | 12.5 | 43.95 | 40.82 | 36.89 | 53.90 | 1.00 | 0.93 | 0.84 | 1.23 |
| 100 | 0 | 71.06 | 68.18 | 59.18 | 78.55 | 1.00 | 0.96 | 0.83 | 1.11 |

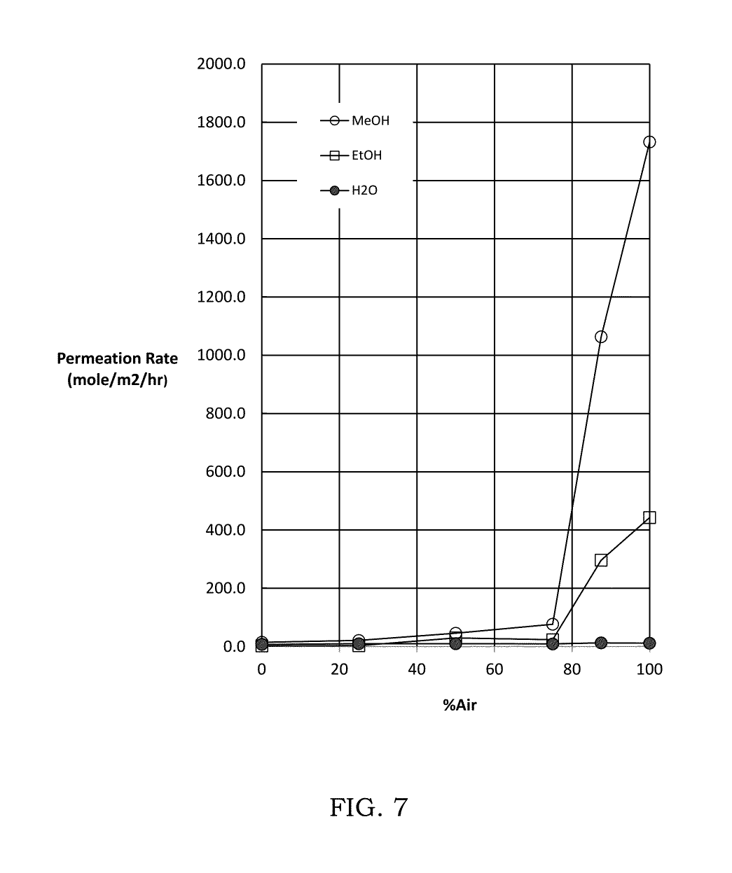

Table 5 contains permeation data on water, methanol, and ethanol through this second set of plasma treated membranes. As before, the data show a dramatic rise in permeability, mass transport, and selectivity ratio for methanol and for ethanol relative to water at oxidizing gas plasma conditions above the 25/75 blend of methane/air. Mass transport rates in moles/m²-hr reached levels as high as 1065 in the case of methanol and as high as 325 in the case of ethanol. These mass transport levels were determined to understate the actual mass transport rates possible under the test conditions, for the reason that rapid cooling of the liquid test fluid occurs because of the endothermic contribution of the heat of vaporization that was involved. Temperatures were monitored during the liquid pervaporation tests during permeability measurements, and it was found that the temperature of methanol at the interface with the membrane, for example, dropped to about 10° C. from an input temperature of 20° C. Because of cooling of the water, methanol, and ethanol test fluids, compensation factors were calculated to correct data to a uniform standard of 20° C. Calculated mass transport rates based on temperature compensation calculations are included at the bottom of Table 5. Temperature compensated mass transport rates reached as high as 1732 moles/m²-hr for methanol and 442 moles/m²-hr for ethanol. FIG. 7 provides a visual picture of the effectiveness of treatment of these membranes with an oxidizing gas plasma in generating highly beneficial alcohol permeabilities compared to water permeation.

TABLE 5

| | CH₄/Air Blend | | | | | |
|---|---|---|---|---|---|---|
| | 100/0 | 75/25 | 50/50 | 25/75 | 12.5/87.5 | 0/100 |
| P/l | | | | | | |
| (cm³/cm²-sec-cmHg) × | | | | | | |
| 10³ | | | | | | |
| H₂O | 2.73 | 3.24 | 3.24 | 3.00 | 4.26 | 4.65 |
| Methanol | 0.88 | 1.17 | 2.17 | 3.29 | 50.68 | 72.52 |
| Ethanol | 0.31 | 0.43 | 3.24 | 2.81 | 30.41 | 48.32 |
| Selectivity Ratio | | | | | | |
| (vs. H₂O) | | | | | | |
| H₂O | 1.00 | 1.00 | 1.00 | 1.00 | 1.00 | 1.00 |
| Methanol | 0.32 | 0.36 | 0.67 | 1.10 | 11.88 | 15.58 |
| Ethanol | 0.11 | 0.13 | 1.06 | 0.94 | 7.13 | 10.38 |
| Mass Transport | | | | | | |
| (moles/m²-hr) | | | | | | |
| H₂O | 7.31 | 8.67 | 8.67 | 8.04 | 11.43 | 12.47 |
| Methanol | 12.95 | 17.25 | 31.92 | 48.30 | 744.35 | 1065.06 |
| Ethanol | 2.10 | 2.91 | 23.04 | 18.93 | 204.73 | 325.36 |
| Temperature- | | | | | | |
| compensated | | | | | | |
| Mass Transport | | | | | | |
| H₂O | 7.5 | 9.4 | 9.4 | 8.8 | 12.5 | 11.3 |
| Methanol | 14.6 | 20.7 | 45.5 | 76.5 | 1063.5 | 1732.6 |
| Ethanol | 2.8 | 2.8 | 29.7 | 23.3 | 296.3 | 442.8 |

What is claimed is:

1. A membrane comprising a layer of a polymer having a fractional free volume of at least 0.25, the polymer layer having a permselective skin at a surface thereof, wherein the permselective skin has been treated with an oxidizing gas plasma, the plasma-treated skin having a transport rate toward methanol of greater than 30 moles/m²-hr and a selectivity of methanol versus water of greater than 1.0 during pervaporation at a vacuum draw of at least 500 mm Hg.

2. The membrane of claim 1 wherein the polymer layer is in the shape of a sheet, tube, or hollow fiber.

3. The membrane of claim 2 wherein the permselective skin is supported by a microporous wall matrix.

4. The membrane of claim 3 wherein the oxidizing gas plasma is formed by glow discharge through a gaseous blend comprising air.

5. The membrane of claim 3 wherein the oxidizing gas plasma is formed by glow discharge through a gaseous blend comprising methane and air.

6. The membrane of claim 3 wherein the skin and wall comprise polymethylpentene.

7. The membrane of claim 6 wherein the permselective skin has a thickness in the range of 0.2 to 2.0 microns.

8. The membrane of claim 7 wherein the oxidizing gas plasma is formed by glow discharge through a gaseous blend comprising oxygen.

9. The membrane of claim 8 wherein the transport rate of methanol is greater than 100 moles/m²-hr and a selectivity of methanol versus water is greater than 5 during pervaporation.

10. The membrane of claim 8 wherein the ethanol transport rate is greater than 100 moles/m²-hr during pervaporation.

11. A membrane comprising polymethylpentene consisting of a skin layer disposed on a microporous supporting layer, wherein the skin layer has been treated with an oxidizing gas plasma formed by glow discharge through a gaseous blend comprising oxygen, wherein the treated skin layer exhibits porous flow behavior toward a group of permanent gases including nitrogen, oxygen, carbon dioxide, and methane, yet also exhibits selectivities for low molecular alcohols including methanol and ethanol versus water of greater than 1.0.

12. The membrane of claim 11 wherein the membrane is in the shape of a sheet, tube, or hollow fiber.

13. The membrane of claim 12 wherein the transport rate of methanol is greater than 100 moles/m²-hr and selectivity of methanol versus water is greater than 5 during pervaporation.

14. The membrane of claim 12 wherein the ethanol transport rate is greater than 100 moles/m²-hr and selectivity of ethanol versus water is greater than 3 during pervaporation.

15. The membrane of claim 12 wherein the oxidizing gas plasma comprises a glow discharge through a blend of methane and air.

16. A device combining both pervaporation and membrane distillation operating characteristics comprising a plurality of membranes, the membranes comprising a polymer having a fractional free volume of at least 0.25, the membranes each having a first and second surface, the membranes having been treated with an oxidizing gas plasma at a first surface, the membranes providing a mass transport rate toward methanol of greater than 100 moles/m²-hr and a selectivity of methanol versus water of greater than 5 when exposed to methanol at the first surface and a vacuum of 500 mm Hg at the second surface.

17. The device of claim 16 wherein the membranes are in the form of hollow fibers.

18. The device of claim 17 wherein methanol transport rate through the hollow fibers exceeds 400 moles/m²-hr at the applied vacuum to one surface of the hollow fibers and the methanol being in liquid contact to an opposite surface of the hollow fibers.

19. The device of claim 17 wherein ethanol transport rate through the hollow fibers exceeds 100 moles/m²-hr at the applied vacuum to one surface of the hollow fibers and the ethanol being in liquid contact to an opposite surface of the hollow fibers.

20. The device of claim 16 wherein the membranes comprise polymethylpentene.
